(19) United States
(12) Patent Application Publication
(10) Pub. No.: US 2016/0071644 A1
(43) Pub. Date: Mar. 10, 2016

(54) COIL ASSEMBLY FOR A DRY TRANSFORMER, METHOD FOR MANUFACTURING A COIL ASSEMBLY AND DRY TRANSFORMER

(71) Applicant: ABB TECHNOLOGY AG, Zurich (CH)

(72) Inventors: Frank Cornelius, Brilon (DE); Magdalena Ostrogorska, Krakow (PL)

(21) Appl. No.: 14/784,589

(22) PCT Filed: Apr. 9, 2014
(86) PCT No.: PCT/EP2014/000950

§ 371 Date: Oct. 15, 2015

(30) Foreign Application Priority Data
Apr. 23, 2013 (EP) 13002131.4

(51) Int. Cl. H01F 27/29; H01F 27/32; H01F 30/12; H01F 27/08

(52) U.S. Cl. CPC H01F 27/29; H01F 27/085; H01F 27/32; H01F 30/12

(57) ABSTRACT

A coil assembly for a dry high-voltage transformer, having at least one coil with hollow cylindrical electrical winding and with taps, wherein the coil is surrounded at least on its radial outer surface by stiff insulation material, wherein a tap-changer is casted on the outer surface of the insulation material, which is electrically connected to the taps, wherein the electrical connection of at least some of the taps is guided at least in part through the insulation material. The tap-changer may be surrounded by a casting material.

### CROSS-REFERENCE TO RELATED APPLICATIONS

This application is a U.S. National Stage Application under 35 U.S.C. §371 of International Application No. PCT/EP2014/000950 filed on Apr. 9, 2014, and claims benefit to European Patent Application No. 1 300 2131.4 filed on Apr. 23, 2013. The International Application was published in English on Oct. 30, 2014, as WO2014173497 A1 under PCT Article 21(2).

### FIELD

The invention is related to a coil assembly for a dry high-voltage transformer.

### BACKGROUND

It is known that transformers are used in electrical distribution networks to adapt the voltage level in between network parts of different rated voltages, for example 30 kV or 60 kV on the high voltage side and 6 kV or 10 kV on the low voltage side. Those transformers have typically a rated power in the range of 0.5 MVA to 10 MVA and are of the type of a dry transformer. For purposes of improved voltage regulation such transformers are combined with an on load tap-changer [OLTC] if required. In this case one of the transformer windings, preferably the high voltage winding, comprises several taps, for example 11 taps in the range between 97% and 103% of the nominal number of loops of this winding. A tap-changer is connecting selectively one of those taps with a connector for the winding. Thus it is possible to influence the behavior of the transformer by temporarily adapting its transmission rate. Typically the switching equipment of the tap-changer is installed in a separate enclosure. The tap connection is conducted via wires from the transformer coil tap to the tap-changer.

### SUMMARY

An aspect of the invention provides a coil assembly for a dry high-voltage transformer, the assembly comprising: a coil including a hollow cylindrical electrical winding including taps, the coil being surrounded at least on its radial outer surface by a stiff insulation material; a tap-changer, casted on an outer surface of the insulation material which is electrically connected to the taps, an electrical connection of at least some of the taps being guided at least in part through the insulation material; and an inlet configured for maintenance of the tap-changer, wherein the tap-changer is surrounded by a casting material, and wherein the tap-changer is arranged at least in part within an encapsulated chasing.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an exemplary first coil with separated tap-changer according to prior art;

FIG. 2 shows an exemplary second coil with tap-changer casted thereon;

FIG. 3 shows an exemplary third coil with tap-changer casted thereon;

FIG. 4 shows an exemplary fourth coil with tap-changer casted thereon; and

FIG. 5 shows exemplary fifth coil with tap-changer casted thereon.

### DETAILED DESCRIPTION

An aspect of invention provides a coil assembly for a dry high-voltage transformer, comprising at least one coil with hollow cylindrical electrical winding and with taps, wherein the coil is surrounded at least on its radial outer surface by a stiff insulation material, wherein a tap-changer is casted on the outer surface of the insulation material, which is electrically connected to the taps, wherein the electrical connection of at least some of the taps is guided at least in part through the insulation material.

Disadvantageously within this state of the art is that the footprint of the transformer assembly is increased significantly therewith and an additional effort for assembly of the tap-changer on site is required. Based on this, an aspect of the invention provides a dry transformer assembly with tap-changer, which is more compact and requires less effort during assembly on site respectively during production. An aspect of the invention is also to provide a respective transformer.

An aspect of the invention provides a coil assembly for a dry high-voltage transformer of the aforementioned kind. This may include a tap-changer that is surrounded by a casting material.

A transformer is typically constructed as a three phase transformer, so the transformer core comprises two yokes and three limbs, wherein a belonging coil with primary and secondary winding is arranged around each limb. Thus on two opposed radial side areas of each coil a space along the whole axis of each coil for arranging a tap-changer or other control equipment is available. A tap-changer attached on such a side area will not increase the overall size of the transformer arrangement in an advantageous way. According to the invention the tap-changer is directly casted on the—preferably radial—outer surface of the coil respectively the insulation material, thus a stiff and reliable connection is gained. By guiding the electrical connection of at least some of the taps through the stiff insulation material, a high degree of protection of the tap-changer respectively its connections is gained against mechanical treatment or stress. This increases the reliability of the transformer in a good way.

According to a further embodiment of the invention the tap-changer is of the type of a power electronic based tap-changer. The use of power electronic components in the rated power classes of approximately 0.5 MVA to 10 MVA is well known, for example as frequency converter for drives or such. Since no mechanical contact element is used the reliability of such a power electronic tap-changer and its expected life time is higher compared with a mechanical tap-changer. This is also of importance, since the access for maintenance of a casted tap-changer might be limited due to the surrounding casting material.

According to another embodiment of the invention the tap-changer is of the type of a vacuum-switch based tap-changer. This provides as well a compact design as a high reliability and life time.

In another variant of the invention the tap-changer is arranged at least in part within an encapsulated chasing. An encapsulated chasing protects the components of the tap-changer from the casting material during the casting process. If the chasing is arranged for example as a tube which is accessible from one or both sides, it is possible to cast only the tube and the electrical connections and mount the main components of the tap-changer later on. This is also of advantage with respect to a curing process of the casting material, which might require additional heat. Thus the main components of the tap-changer are not subject to a heating process during production of the transformer since they are mounted afterwards.

According to another variant of the invention an inlet for maintenance of the tap-changer is foreseen. This could become for example realized as access from one or both sides of a tube-like chasing as mentioned before. Even the tap-changer is of a type of high reliability and long lifetime such a maintenance access, arranged preferably on the side of an encapsulating chasing, easily enables a repair, replacement or maintenance of a tap-changer.

According to a further variant of the invention the tap-changer respectively its chasing is surrounded at least predominantly by a casting material. Thus the tap changer is protected against mechanical forces or stress from outside in a very good way. Transportation or arrangement of the transformer on site becomes easier.

According to a special embodiment of the invention the stiff insulation material surrounding the coil is the same than the casting material. Preferably the surrounding insulation material of the coil and the surrounding insulation material of the tap-changer have been casted together in the same casting process. Thus one step within the production is eliminated and production becomes easier therewith.

According to a further embodiment of the invention the stiff insulation material surrounding the coil is a resin impregnated roving which is wound around the coil. The use of such rovings, which might also be fiber based, is successfully used for the insulation of dry transformer coils since a longer time. Anyhow, the outer surface of such an insulation layer is suitable for casting some objects like a tap-changer respectively a chasing on it.

According to a further embodiment of the invention at least some of the roving windings are wound around the tap-changer respectively its chasing. Thus a good fixation of the tap-changer is provided during the casting process.

According to a preferred embodiment of the invention cooling channels are foreseen in between the outer surface of the coil and the tap-changer. Due to unavoidable losses during operation a transformer coil is a heat source. By using cooling channels the tap-changer becomes on one side thermally insulated from the heat source and is on the other side cooled by a flowing cooling liquid such as air. This is important since also the tap-changer itself might be a source of heat, for example if it is realized by use of power electronic components. Thermal stress for the tap changer is reduced in an advantageous way therewith. Of course additional cooling means like heat exchanger or a blower or such can be foreseen.

According to a further variant of the invention the tap-changer is arranged in a section of the axial length of the coil with reduced heat emission during operation. An example for this is an axially separated coil, wherein the upper half is subject to a higher heat emission than the lower half. Since the axial length of a tap-changer might be less than the axial height of a transformer coil, the tap changer is preferably casted on an outer area of the surface of the coil, where the heat emission is lowest.

The problem of the invention is also solved by a dry transformer, comprising at least a transformer core and a coil according to the invention. The respective advantages have already been described for the coil with tap-changer casted thereon.

According to a preferred embodiment of the transformer according to the invention it comprises three coils with tap-changer casted thereon in an electrical three phase connection. This enables the transformer to be used in a three phase transmission network. Each coil comprises a low-voltage and a high-voltage winding, wherein the respective tap-changer is normally electrically arranged on the high voltage side.

Further advantageous embodiments of the invention are mentioned in the dependent claims.

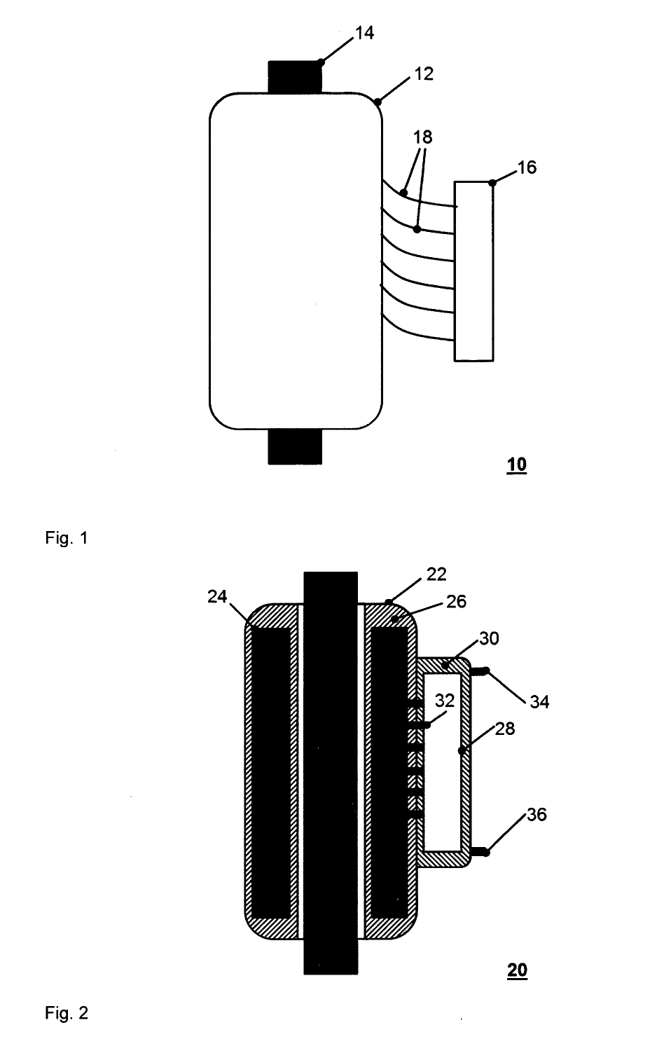

FIG. 1 shows an exemplary first coil assembly with separated tap-changer according to prior art in a sketch 10. A hollow cylindrical coil 12 is arranged around the limb 14 of a not shown transformer. The coil 12 comprises a low-voltage and a high-voltage winding, wherein the high-voltage winding comprises several tabs which are connected to a tap-changer 16 remote therefrom by use of connections 18, in this case wires. The footprint of such an arrangement is disadvantageously increased compared to a coil with tap-changer casted thereon.

FIG. 2 shows an exemplary second coil with tap-changer casted thereon in a cross-sectional view 20. A hollow cylindrical coil 22 is arranged around the limb of a not shown transformer. The coil 22 comprises a hollow cylindrical winding 24, which is surrounded by a stiff insulation material 26. In this case the stiff insulation material 26 is a resin impregnated fiber roving. The winding 26 has several taps, which are connected with a tap-changer 28 by use of electrical connections 32. The electrical connections 32 are guided through the stiff insulation material 32 and through a casting material 30, which is surrounding the tap-changer 28.

As well the connections 32 as the tap-changer 28 itself is protected in a good way against mechanical treatment by the surrounding stiff insulation material 26 respectively the casting material 30. The tap changer 28 is of a power-electronic based type. The winding 24 and the tap-changer 28 have in total two electrical contacts 34, 36 which are lead through the casting material 30. The footprint of such an arrangement is not significantly higher than the footprint of the coil 24 as such.

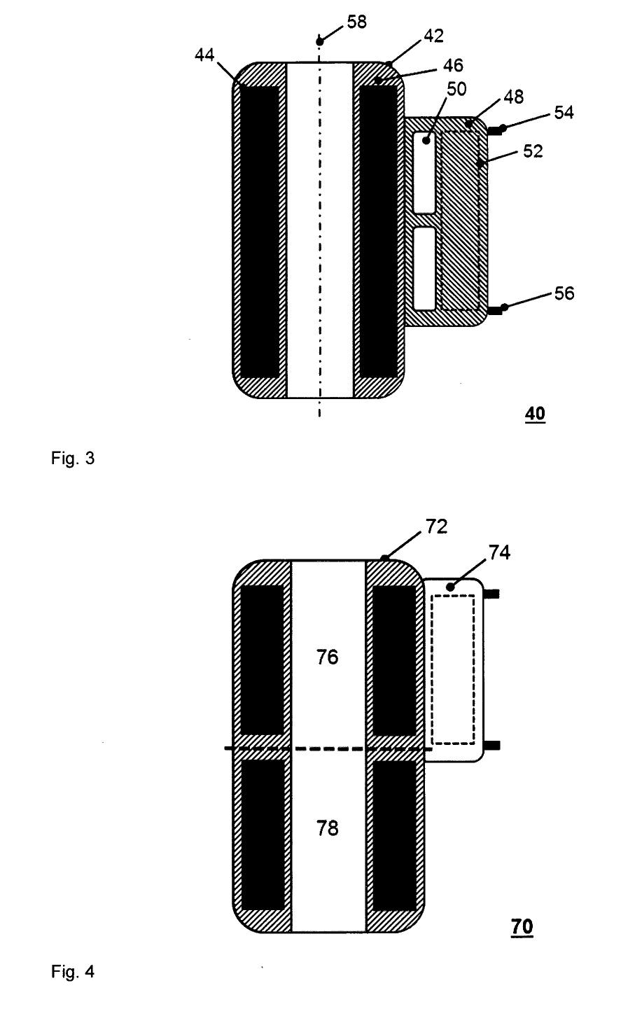

FIG. 3 shows an exemplary third coil with tap-changer casted thereon in a cross-sectional view 40. A hollow cylindrical coil 42 is arranged around a virtual winding axis 58. The coil 42 comprises a hollow cylindrical winding 44, which is surrounded by a stiff insulation material 46. In this case the stiff insulation material 46 is a casting material. A tap changer 52 is casted on the surface of the winding by use of a surrounding casting material 48. Both casting materials are identical and have been casted within the same casting process. But it is also possible to cast different casting materials in one go. To reduce thermal stress on the tap-changer 52, cooling channels 50 are foreseen in between the coil 42 and the tap changer 52. Electrical connections 54, 56 are led through the casting material.

FIG. 4 shows an exemplary fourth coil 72 with tap-changer 74 casted thereon in a cross-sectional view 70. The upper half of the coil 72 is subject to less heat emission than the lower half. To reduce thermal stress on the tap-changer 74 it is casted on the lower part of the coil 72.

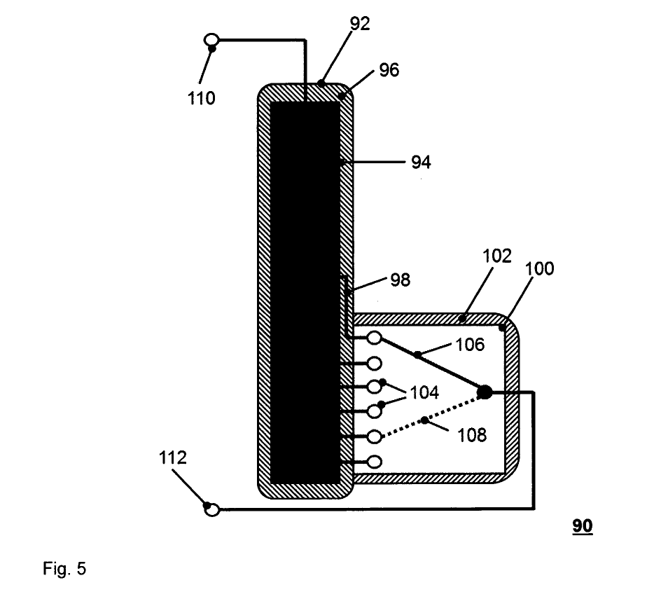

FIG. 5 shows exemplary fifth coil with 92 a tap-changer 100 casted thereon in a schematic cross-sectional view 90. The coil 92 comprises a winding 94 which is surrounded by a stiff insulation material 96. Taps 104 of the winding 94 are lead through the insulation material 96 to the tap-changer 100. That's functionality is indicated in an electrical manner. Exactly one tap 104 can become connected with the output of the tap changer 100 by use of a selector switch, as indicated with the two states 106 and 108. The output of the tap changer and a respective connection of the winding are provided as electrical contacts 110 respectively 112. Preferably the selector switch is either based on power electronic components or on vacuum-switches.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SIGNS

10 exemplary first coil with separated tap-changer according to prior art

12 exemplary coil

14 limb of transformer core

16 exemplary first tap-changer

18 external connections from coil to tap-changer

20 exemplary second coil with tap-changer casted thereon

22 exemplary second coil

24 exemplary winding

26 stiff insulation material

28 exemplary second tap-changer

30 casting material

32 electrical connection

34 first contact of second coil with tap-changer

36 second contact of second coil with tap-changer

40 exemplary third coil with tap-changer casted thereon

42 exemplary third coil

44 exemplary winding

46 stiff insulation material

48 casting material

50 cooling channel

52 exemplary third tap-changer

54 first contact of third coil with tap-changer

56 second contact of third coil with tap-changer

58 virtual winding axis

70 exemplary fourth coil with tap-changer casted thereon

72 exemplary fourth coil

74 fourth tap-changer surrounded by casting material

76 upper part of coil with lower heat emission

78 lower part of coil with higher heat emission

90 exemplary fifth coil with tap-changer casted thereon

92 exemplary fifth coil

94 exemplary winding

96 stiff insulation material

98 electrical connection parallel to winding axis

100 exemplary fifth tap-changer

102 casting material

104 transformer tap

106 first state of selector switch

108 second state of selector switch

110 first contact of coil with tap-changer

112 second contact of coil with tap-changer

1. A coil assembly for a dry high-voltage transformer, the assembly comprising:
a coil including a hollow cylindrical electrical winding and including taps, the coil being surrounded at least on its radial outer surface by a stiff insulation material;
a tap-changer, casted on an outer surface of the insulation material, which is electrically connected to the taps, an electrical connection of at least some of the taps is being guided at least in part through the insulation material; and
an inlet configured for maintenance of the tap-changer,
wherein the tap-changer is surrounded by a casting material, and
wherein the tap-changer is arranged at least in part within an encapsulated chasing.

2. The assembly of claim 1, wherein the tap-changer is configured as a power electronic based tap-changer.

3. The assembly of claim 1, wherein the tap-changer is configured as a vacuum-switch based tap-changer.

4-5. (canceled)

6. The assembly of claim 1, wherein the stiff insulation material is the same as the casting material.

7. The assembly of claim 1 wherein the stiff insulation material is a resin impregnated roving which is wound around the coil.

8. The assembly of claim 6, wherein at least some of the roving windings are wound around the tap-changer.

9. The assembly of claim 1, further comprising:
cooling channels in between in between the outer surface of the coil and the tap-changer.

10. The assembly of claim 1, wherein the tap-changer is arranged in a section of an axial length of the coil with reduced heat emission during operation.

11. (canceled)

12. A dry transformer, comprising:
a transformer core; and
the coil assembly of claim 1.

13. The transformer of claim 12, comprising:
at least three coils in an electrical three phase connection.

14. The transformer of claim 12, comprising:
three coils in an electrical three phase connection.

15. The assembly of claim 1, comprising more than one of the coil.

16. The assembly of claim 1, wherein the stiff insulation material includes a resin impregnated roving.

17. The assembly of claim 1, wherein the stiff insulation material includes a resin impregnated roving which is wound around the coil.

18. The assembly of claim 5, wherein at least some of the roving windings are wound around a surrounding casting material of the tap-changer.
